(19) United States
(12) Patent Application Publication
(10) Pub. No.: US 2018/0137789 A1
(43) Pub. Date: May 17, 2018

(54) MAGNETIC MOUNTING SYSTEM

(71) Applicants: Robert Booth Murray, III, Springfield, MO (US); Ashley Tyler Burchfield, Springfield, MO (US); David Lee Hogan, Springfield, MO (US)

(72) Inventors: Robert Booth Murray, III, Springfield, MO (US); Ashley Tyler Burchfield, Springfield, MO (US); David Lee Hogan, Springfield, MO (US)

(21) Appl. No.: 15/811,332

(22) Filed: Nov. 13, 2017

Related U.S. Application Data
(60) Provisional application No. 62/420,906, filed on Nov. 11, 2016.

(51) Int. Cl. G09F 7/04; H01F 7/02; A47G 1/17

(52) U.S. Cl. CPC G09F 7/04; F16M 13/022; A47G 1/17; H01F 7/0257

(57) ABSTRACT

A magnetic mounting system configured to mount various items onto a surface or structure while allowing for ease of customization of the mounted item without damaging the surface or structure. The magnetic mounting system comprising a plate including a front surface and a back surface, at least one plate mount, and at least one display mount. The plate is received by the at least one plate mount at the back surface of the plate and the at least one display mount is received by the plate at the front surface. The at least one display mount is configured to receive an item, such that the item can be mounted to the front surface of the plate. The at least one plate mount is configured to be coupled to a wall or surface, such that the plate can be removably mounted to the wall or surface.

### RELATED APPLICATION

This application claims the benefit of priority under 35 USC 119(e) to U.S. Provisional Application Ser. No. 62/420,906 to Murray et al., which was filed on Nov. 11, 2016. U.S. Provisional Application Ser. No. 62/420,906 including its drawings, schematics, diagrams, and written description, is hereby incorporated in its entirety by reference.

### BACKGROUND

### Field

This disclosure relates to a mounting system adapted to be used to mount an item to a surface or structure. More specifically, the disclosure is directed to a magnetic mounting system that is configured to mount an item onto a surface or structure.

### Description of the Related Art

Mounting an item to a wall or surface typically requires installing a fastener or wall anchor into the wall and then hanging the item from the fastener. Mounting lightweight and medium-weight items onto walls can be typically done using a nail or screw anchor as the fastener. Mounting heavier objects to a wall would typically require support hardware that attaches to the wall framing and/or clamps to an interior surface of the wall.

The type of fastener or wall anchor used to mount an item to a wall is often determined by the wall material. Standard picture hangers or wire hangers work fine with drywall and wood. However, wall anchors or toggle bolts would be needed to mount heavy items to drywall or wood walls. Masonry and concrete walls require plastic anchors or masonry nails in order to mount the item to such walls. These type of anchors allow the item to be mounted to the wall, but adjusting the position of the item on the wall requires installing the anchor in a desired adjusted position, which further requires a new hole in the wall at the desired adjusted position. The desired adjusted position cannot be too close to the original position, because if the new hole is close to the original position the structural integrity of the wall can become comprised and/or weak, which could lead to the wall breaking. The desired adjusted position of the anchor must be sufficiently separated from the original position, so as to not compromise the structural support of the wall. As such, these anchors could prevent the positioning of the mounted item from being slightly adjusted.

Reinstalling the anchor in the new position on the wall is not always possible and could require using a new anchor as well as drilling a new hole in the new location. For instance, typical plastic wall anchors expand when a screw is screwed into the plastic wall anchor. The expanding of the plastic wall anchor allows the plastic wall anchor to grab hold of the wall such that the plastic wall anchor is held snug in the wall. Removing the plastic wall anchor would show that the plastic wall anchor has split open due to the expansion and may not be suited for reuse. Additionally, toggle bolts are typically spring-loaded and grab a hold of an interior surface of the wall. Removing the spring-loaded toggle is difficult without damaging the wall. Typically, removing the bolt connected to the spring-loaded toggle results in the spring-loaded toggle remaining within the interior wall cavity, thereby requiring another spring-loaded toggle if the initial location of the toggle bolt is to be changed.

Magnets can be used to mount an item to a metallic wall or surface. The most common situation is using a magnet to display an item on a refrigerator. The refrigerator is metallic and magnets will stick onto the refrigerator due to the magnetic field produced by the magnet. Using magnets on a metallic wall or surface does not require any anchors that pierce the metallic wall. However, using a magnet and a metallic wall typically requires the item to be interposed between the wall and the magnet in order to mount the item to the wall. This configuration could cause damage to the item due to the item being interposed between the wall and the magnet for extended periods of time. In some instances, the item may not be suitably arranged to allow for the item to be interposed between the wall and the magnet, thereby preventing the magnet from mounting the item to the wall. Additionally, the holding force of the magnet is dependent upon the friction between the item and the magnet. The holding force of the magnet is also dependent upon the thickness and materials of the item. The thicker the item, the less magnetic force that can be applied by the magnet to hold the item up against the wall. Furthermore, having the item interposed between the wall and the magnet results in the magnet blocking and/or covering part of the item and could detract from the aesthetic properties of the mounted item. If more than one magnet is required to mount the item to the wall, then this results in multiple magnets covering the mounted item and could further diminish the artistic and/or visual appealing features of the mounted item.

Adjusting the position of the item mounted to the wall by the magnet can be done by holding onto the item and then removing the magnet, repositioning the item to a desired position on the wall, and then reapplying the magnet onto the item. However, in instances where more than one magnet is used to mount the item to the wall, each magnet must be removed in order to reposition the item to the desired position, and then each magnet can be reapplied onto the item. This can be cumbersome and does not provide for ease of customization, especially in instances where there are multiple magnets. Namely because in removing the magnets another force must be applied to hold up the item so that it does not fall when one or more magnets are removed. An individual must hold up the item with one hand, and remove the magnets with the other. Heavier items may require more than one person.

The disclosure is a magnetic mounting system that is configured to mount an item onto a surface or structure. For example, the magnetic mounting system can be configured to mount various items onto a surface while allowing for ease of customization of the mounted item without damaging the surface or structure. The present disclosure addresses these needs and provides further related advantages.

### SUMMARY

The disclosure disclosed herein provides various aspects of a magnetic mounting system that is cost effective, easy to assemble/disassemble, and provides the required support to mount an item to a wall or surface. The different aspects comprise elements to allow the magnetic mounting system to be configured into different arrangements, such that the system can be used to mount various items to the same and/or different surfaces. The magnetic mounting system is configured to be modular, allowing for multiple magnetic mounting systems to be used in combination. The magnetic mounting system allows for the mounted item to be easily customized, such that the positioning of the mounted item can be easily repositioned without having to remount a structural support component. The disclosure is also configured such that the magnetic mounting system does not diminish the artistic and/or visual appealing features of the mounted item.

In one aspect, as broadly described herein, a magnetic mounting system comprises a plate comprising a front surface and a back surface, at least one plate mount, and at least one display mount. The plate is received by the at least one plate mount at the back surface of the plate and the at least one display mount is received by the plate at the front surface. The at least one display mount is configured to receive an item, such that the item can be mounted to the front surface of the plate. The at least one plate mount is configured to be coupled to a wall or surface, such that the plate can be removably mounted to the wall or surface when the back surface of the plate is received by the at least one plate mount.

In another aspect, a magnetic mounting system comprises a main plate, at least one display plate, at least one main plate mount, and at least one display mount. The main plate comprises a front surface and a back surface and is received by the at least one main plate mount at the back surface. The at least one display mount is received by the main plate at the front surface of the main plate. The at least one display mount is configured to receive an item, such that the item can be mounted to the front surface of the main plate. The at least one display mount can also be configured to receive the at least one display plate, such that the at least one display plate can be mounted to the front surface of the main plate. The at least one main plate mount can be removably coupled to a wall or surface, such that the main plate can be removably coupled to the wall or surface.

In another aspect, a magnetic mounting system comprises a mount plate comprising a front surface and a back surface, a display mount removably coupled to the front surface of the mount plate, wherein the display mount is configured to receive an item, such that the item can be displayed on the mount plate. The display mount can comprise at least one magnet within the display mount such that magnetic forces couple the display mount to the mount plate. The mount plate can be comprised of material attracted to magnetic forces, such that the display mount can be mounted onto the mount plate.

These and other aspects and advantages of the disclosure will become apparent from the following description and accompanying drawings which illustrate, by way of example, features of the disclosure.

### BRIEF DESCRIPTION OF THE DRAWINGS

FIG. 1 is a perspective view of a magnetic mounting system according to an aspect of the disclosure.

FIG. 2a is a cross sectional view of a magnetic mounting system according to an aspect of the disclosure.

FIG. 2b is a cross sectional view of a magnetic mounting system according to an aspect of the disclosure.

FIG. 2c is a cross sectional view of a magnetic mounting system according to an aspect of the disclosure.

FIG. 3a is a cross sectional view of a magnetic mounting system according to an aspect of the disclosure.

FIG. 3b is a cross sectional view of a magnetic mounting system according to an aspect of the disclosure.

FIG. 3c is a cross sectional view of a magnetic mounting system according to an aspect of the disclosure.

FIG. 4 is a perspective view of a plate mount according to an aspect of the disclosure.

FIG. 5 is a perspective view of another plate mount according to an aspect of the disclosure.

FIG. 6 is a perspective view of a display mount according to an aspect of the disclosure.

FIG. 7 is a perspective view of another display mount according to an aspect of the disclosure.

FIG. 8 is a perspective view of display mounts according to aspects of the disclosure.

FIG. 9 is a perspective view of a display mount according to an aspect of the disclosure.

FIG. 10 is a perspective view of a display mount according to an aspect of the disclosure.

FIG. 11 is a perspective view of an item mounted with the display mount of FIG. 10.

FIG. 12 is a perspective view of a plate according to an aspect of the disclosure.

FIG. 13 is a perspective view of a magnetic mounting system according to an aspect of the disclosure.

FIG. 14 is a perspective view of a magnetic mounting system according to an aspect of the disclosure.

FIG. 15 is a perspective view a magnetic mounting system according to an aspect of the disclosure.

FIG. 16 is a close-up view of the magnetic mounting system of FIG. 15.

FIG. 17 is a perspective view of a magnetic mounting system according to an aspect of the disclosure.

FIG. 18 is a perspective view of a magnetic mounting system according to an aspect of the disclosure.

FIG. 19 is a perspective view of a magnetic mounting system according to an aspect of the disclosure.

FIG. 20 is a perspective view of a magnetic mounting system according to an aspect of the disclosure.

FIG. 21 is a perspective view of a magnetic mounting system according to an aspect of the disclosure.

FIG. 22 is a close-up view of the magnetic mounting system of FIG. 21.

FIG. 23 is another close-up view of the magnetic mounting system of FIG. 21.

FIG. 24 is another close-up view of the magnetic mounting system of FIG. 21.

FIG. 25 is another close-up view of the magnetic mounting system of FIG. 21.

FIG. 26 is a perspective view of a magnetic mounting system according to an aspect of the disclosure.

FIG. 27 is a close-up view of the magnetic mounting system of FIG. 26.

FIG. 28 is a perspective view of a magnetic mounting system according to an aspect of the disclosure.

FIG. 29 is a perspective view of display mounts according to aspects of the disclosure.

FIG. 30 is a perspective view of a magnetic mounting system according to an aspect of the disclosure.

FIG. 31 is a side view of the magnetic mounting system of FIG. 30.

FIG. 32 is a perspective view of a magnetic mounting system according to an aspect of the disclosure.

FIG. 33 is a perspective view of a magnetic mounting system according to an aspect of the disclosure.

FIG. 34 is a side view of the magnetic mounting system of FIG. 33.

FIG. 35 is a perspective view of magnetic mounts according to aspects of the disclosure.

FIG. 36 is a perspective view of a magnetic mounting system according to an aspect of the disclosure.

FIG. 37 is a side view of the magnetic mounting system of FIG. 36.

### DETAILED DESCRIPTION

The disclosure described herein is directed to different aspects of a magnetic mounting system that in some aspects allows for an item to be mounted using magnetic mounts to a wall or surface that is easy to setup and easily customizable. The magnetic mounting system can comprise many different materials and can be used in many different applications such as, but not limited to, displaying artwork, sports equipment, memorabilia, photographs, mementos, souvenirs, advertisements, merchandise. The magnetic mounting system according to the disclosure can be arranged in many different ways with many different components, and is generally arranged to provide a mounting system to magnetically mount an item to a wall, structure or surface.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

In one aspect, as broadly described herein, a magnetic mounting system comprises a plate comprising a front surface and a back surface, at least one plate mount, and at least one display mount. The plate is received by the at least one plate mount at the back surface of the plate and the at least one display mount is received by the plate at the front surface. The at least one display mount is configured to receive an item, such that the item can be mounted to the front surface of the plate. The at least one plate mount is configured to be coupled to a wall or surface, such that the plate can be removably mounted to the wall or surface when the back surface of the plate is received by the at least one plate mount. The plate can be easily adjusted by removing it from the at least one plate mount and repositioning the plate at the new desired position. The magnetic mounting system eliminates the need of having to reposition the at least one plate mount to the new desired position.

The magnetic mounting system can provide a number of additional advantages beyond those mentioned above. For example, the plate receiving the at least one display mount allows for the item mounted to the plate to be easily adjusted without having to pierce the plate at the new desired position. Additionally, the at least one display mount can be configured to receive the item such that the display mount does not interfere with the visual aesthetics of the item displayed and/or the plate. In some aspects, the at least one display mount can be configured such that part of the display mount is interposed between the plate and the item, such that the display mount do not cover the item. Conventional magnetic mounts require the item to be interposed between the magnet and the mount surface, which results in the magnet covering part of the item. The magnetic mounting system of the disclosure overcomes such instances, and allows the item to be substantially uncovered when mounted to the plate.

Some aspects of the magnetic mounting system according to the disclosure can be used to mount an item to a plate. However, the disclosure is not intended to be limited to such aspects. As further described below, the magnetic mounting system can be arranged to allow an individual to easily display items with respect to a custom plate. For example, the custom plate can comprise a printed matter on the front surface, such as but not limited to a fishing trip, landscape, scenery, family portraits, sporting events, or the like, and/or a combination thereof. The display mount can be used to display an item associated with the fishing trip on the front surface, such as but not limited to a fishing lure, rod, or the like. The arrangement of items on the front surface is easily customizable based on the user. The magnetic mount system being highly customable does not require fasteners to pierce the plate, as is required in typical fasteners.

The disclosure is described herein with reference to certain aspects, but it is understood that the disclosure can be embodied in many different forms and should not be construed as limited to the aspects set forth herein. In particular, the disclosure is described below in regards to a magnetic mounting system to mount an item to a wall or surface, but it is understood that the disclosure can be used for many other applications in many different settings. The components of the magnetic mounting system can have different shapes and sizes beyond those shown in the figures or discussed herein.

Although the terms first, second, etc. may be used herein to describe various elements or components, these elements or components should not be limited by these terms. These terms are only used to distinguish one element or component from another. Thus, a first element discussed herein could be termed a second element without departing from the teachings of the disclosure. It is understood that actual magnetic mounting systems embodying the disclosure can be arranged in many different ways with many more features and elements beyond what is shown in the figures.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the device in addition to the orientation depicted in the figures.

Aspects of the disclosure are described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the disclosure.

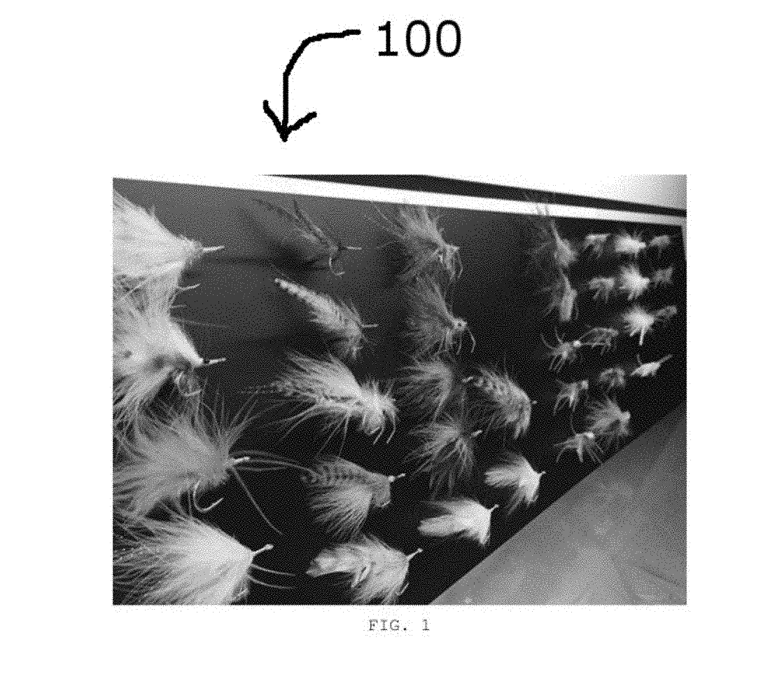

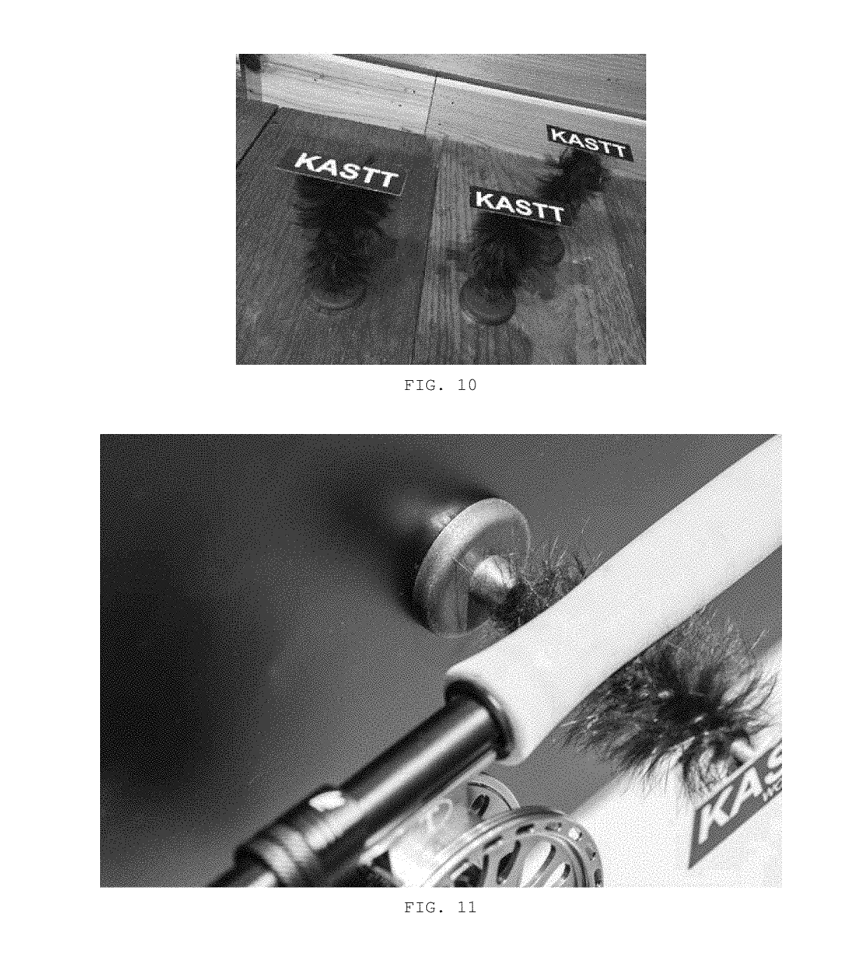

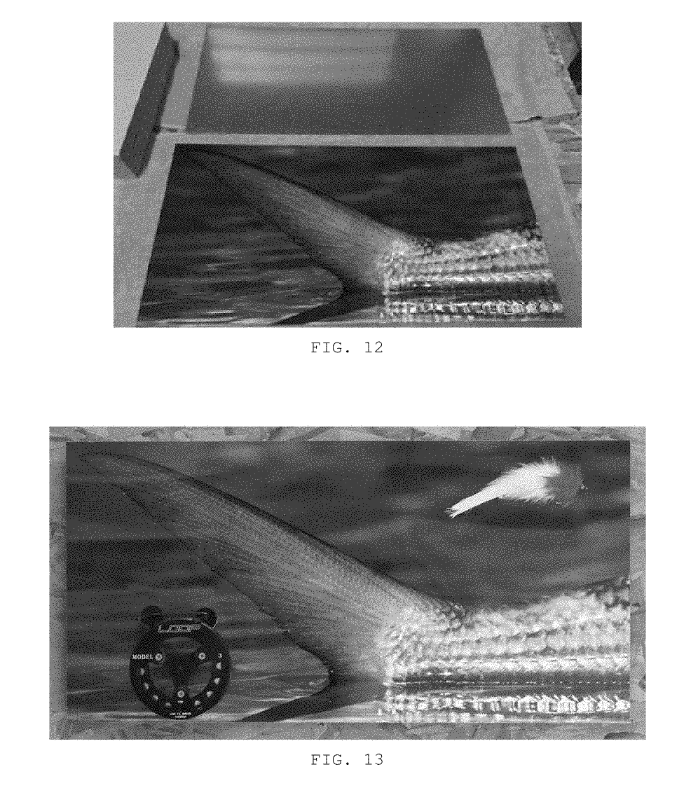

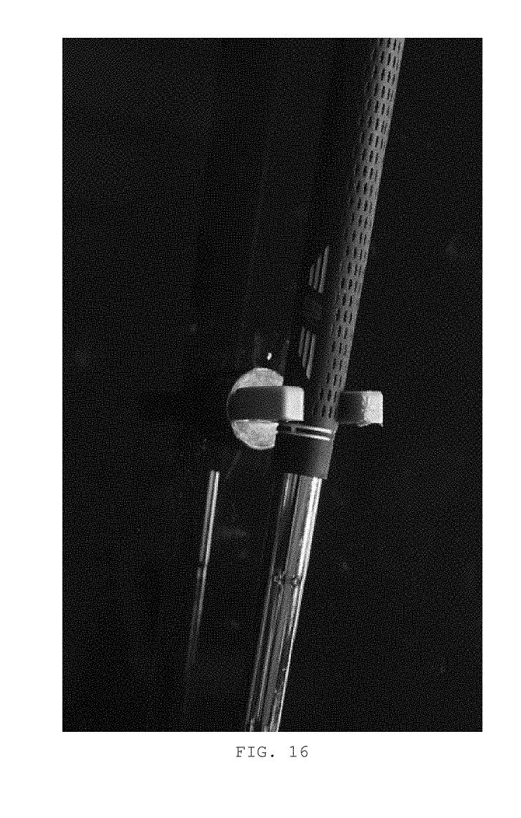

FIGS. 1-16 show an aspect of a magnetic mounting system 100 according to the disclosure. In some aspects, the magnetic mounting system 100 is configured such that an item can be mounted in many different settings and/or many different surfaces. The magnetic mounting system 100 can be used to mount many different items onto many different surfaces. The magnetic mounting system 100 can also be used to allow users to easily adjust and/or reposition the mounted item without having to pierce the mount surface with an anchor or fastener. The ease of adjustability of the magnetic mounting system 100 allows users to alter the arrangement of the mounted item based on many factors, such as but not limited to, personal preference, to accommodate other mounted items, graphic features on the surface, or the like.

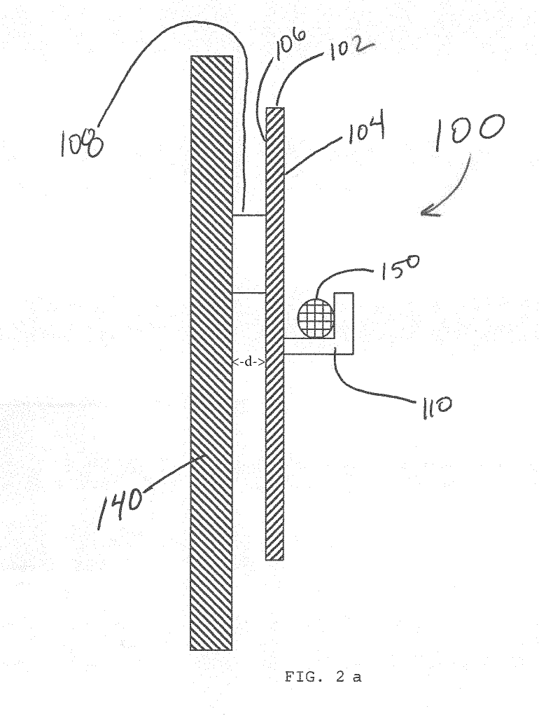

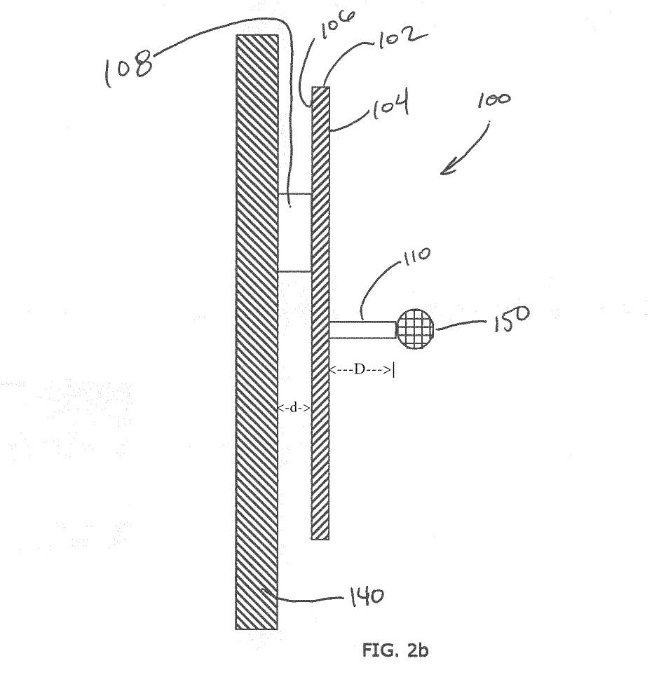

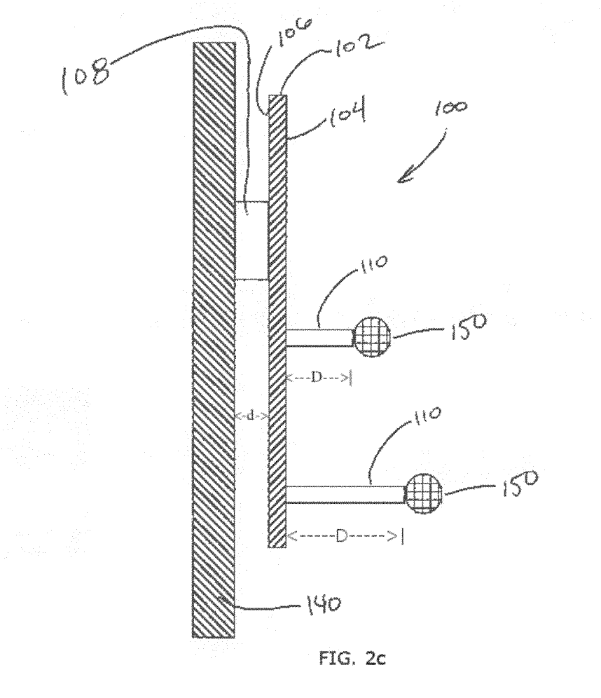

In one aspect of a magnetic mounting system 100, as shown in FIG. 2, the magnetic mounting system comprises a plate 102 comprising a front surface 104 and a back surface 106, at least one plate mount 108, and at least one display mount 110, wherein the plate mount 108 is configured to receive the plate 102 at the back surface 106 of the plate 102. The plate 102 is configured to receive at least one display mount 110 at the front surface 104 of the plate 102. The at least one display mount 110 is configured to receive an item 150, such that the item 150 can be mounted to a wall or surface 140. The at least one plate mount 108 is configured to be coupled to the wall or surface 140, whereby the plate 102 can be removably coupled to the wall or surface 140 when received by the at least one plate mount 108. This allows the plate 102 to be easily adjusted by removing it from the at least one plate mount 108 and repositioning the plate 102 at the new desired position. The plate 102 mounted on the at least one display mount 110 is positioned such that the plate 102 is within a first plane. The front surface 104 of the plate 102 extends along the first plane, such that the item 150 is displaced from the first plane. Additionally, the at least one display mount 110 is arranged such that the item 150 can be positioned within a second plane. The second plane is offset from the first plane based on the dimensions of the at least one display mount 110. The at least one display mount 110 provides a surface to receive the item 150 that is within the second plane. The surface provided by the at least one display mount 110 can be the same or different to the front surface 104 of the plate 102. In some aspects, as shown in FIG. 2c, multiple items can be mounted onto the front surface 104 wherein each respective item is mounted by a respective at least one display mount 110. In such aspects, each item can be offset from the front surface 104 at the same and/or different distance, such that each item can be within a same and/or different second plane.

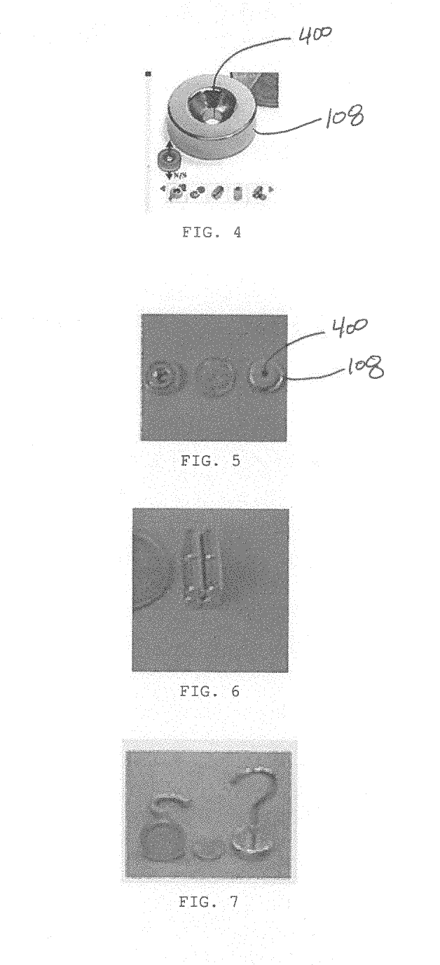

In some aspects, the at least one plate mount 108 can comprise a magnetic plate mount 108. The magnetic plate mount 108 is secured to the wall or surface 140 and holds the plate 102 to the wall or surface to allow for mounting one or more items 150 onto the front surface 104 of the plate 102, such that the item 150 is mounted to the wall or surface 140. The magnetic plate mount 108 can be mounted to the wall or surface 140 using many different anchors and/or fasteners known in the art. In some aspects, the magnetic plate mount 108 can comprise a cup magnet. Cup magnets direct substantially all the magnetic power in one direction. In some aspects, as shown in FIGS. 4 and 5, the magnetic plate mount 108 can comprise an opening 400 configured to receive a fastener (not shown) in order to mount the magnetic plate mount 108 to the wall or surface. The opening 400 can be in many different locations within the magnetic plate mount 108, while in one aspect, the magnetic plate mount 108 comprises a central opening 400. The magnetic plate mount can be arranged in many different configurations and is not intended to be limited to a cup magnet. In some aspects, the magnetic plate mount can be ring shaped, square, rectangular, quadrilateral, or any polygon. The magnetic plate mount can comprise many different dimensions and/or more than one openings 400 in order to mount the plate mount to the surface. In some aspects, the magnetic plate mount can comprise a height of at least ¼″ or higher. However, in other aspects, the magnetic plate mount can have a height that is less than and/or greater than ¼″. The height of the magnetic plate mount allows the plate to be offset from the wall or surface such that the plate appears to float off of the wall or surface. In the aspect of FIG. 2a, the plate is offset from the wall or surface by a distance “d”. The magnetic plate mount can comprise many different magnets known in the art, such as but not limited to, neodymium magnets, rare earth magnets, and/or the like. The magnetic plate mount has a holding power sufficient to hold the plate, the at least one display mount and the mounted item. The type and/or number of magnetic plate mounts needed for a given configuration can be determined by the total weight the plate, the at least one display mount, and the mounted item.

The at least one plate 102 can be configured to be received by the at least one plate mount 108 such that the at least one plate 102 can receive the at least one display mount 110. Upon the mounting of the at least one plate mount 108 to the wall or surface 140, the plate 102 can be received by the at least one plate mount 108 and mounted onto the wall or surface 140, such that the plate 102 is held in place by the at least one plate mount 108. In some aspects, the plate 102 is held in place onto the wall 140 by the magnetic plate mount 108. The plate 102 is configured to be attracted to magnets, wherein the magnetic properties of the magnetic plate mount 108 securely hold the plate 102 to the wall 140. In some aspects, the plate 102 can be comprised of galvanized steel. However, the disclosure is not intended to be limited to plates being comprised of galvanized steel. In some aspects, the plate can be comprised of other materials that are attracted to magnets in addition to galvanized steel. At least one advantage of the plate being comprised of galvanized steel is that galvanized steel does not rust and also has high magnetic qualities. As such, plates comprised of galvanized steel can be mounted in various external settings without degradation due to exposure to environmental conditions. In some aspects, galvanized steel within the range of 20-24 gauge can be used for the plate, wherein a higher gauge results in thinner steel, while a thicker piece of steel provides a higher holding power for magnets. However, various gauges of steel within a range that is greater than and/or less than 20-24 can be used. The disclosure is not intended to be limited to using galvanized steel within the range of 20-24 gauge. In some aspects, the plate can be powder coated in order to provide some protection to the plate such that it does not get damaged and/or scratched. The plate can also, or in the alternative, be painted to any desired color. At least one advantage of the disclosure is that the plate can be configured in many different ways and can be customized based on the items to be mounted. For example, the plate can be any shape, any color, and/or comprise graphics on the front surface of the plate. The customization of the plate allows for the plate to be utilized as a decorative piece that can correspond with the item(s) to be mounted onto the plate. In addition, as further discussed below, the display mounts 110 can be magnetic, such that the item(s) mounted on the plate are not permanently affixed and can be easily adjusted to a different orientation and/or to a different location on the plate, which further allows for the customization of the item(s) with respect to the plate.

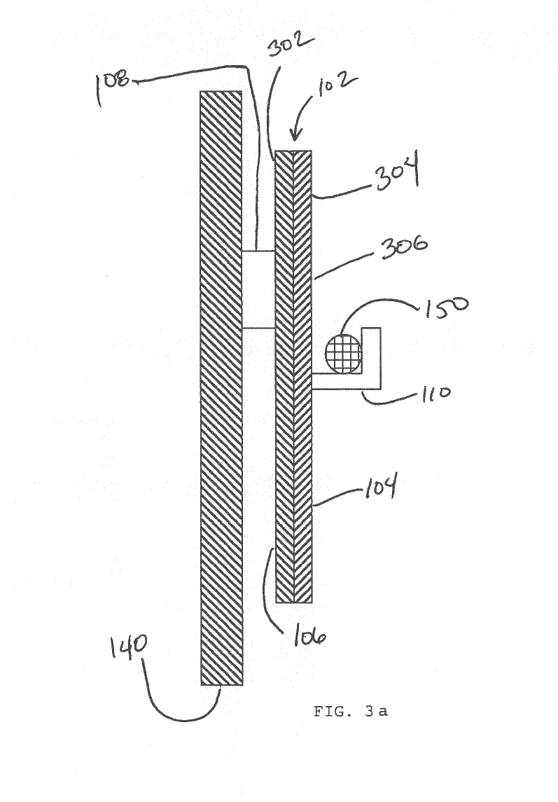

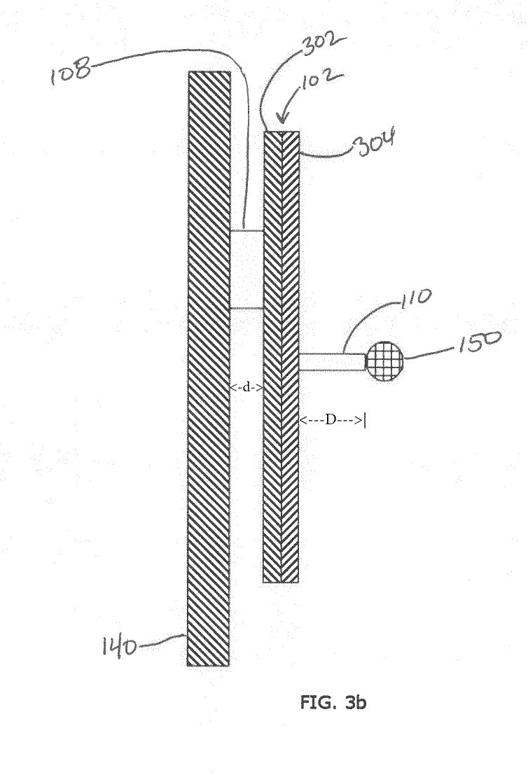

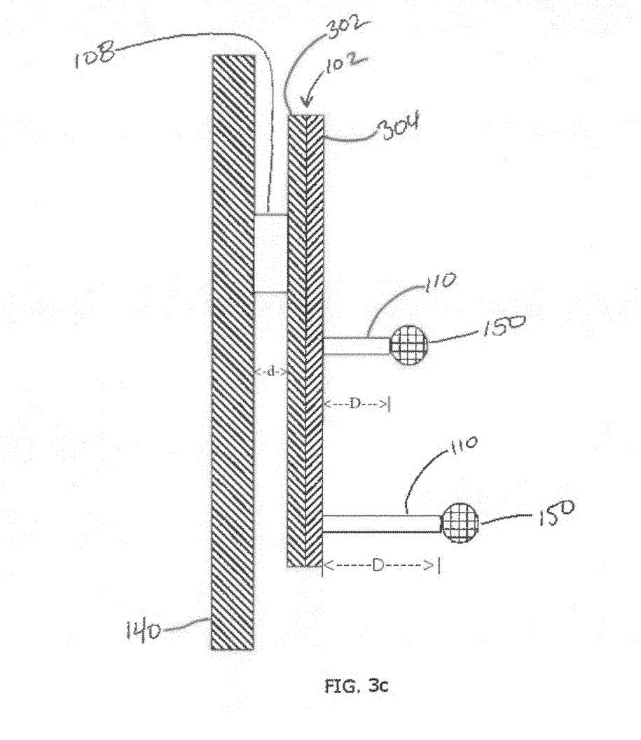

In some aspects, the plate 102 can be comprised of a plurality of plates. In some aspects, as shown in FIGS. 3a-3c, a first plate 302 and a second plate 304 can be coupled together to form the plate 102, such that the back surface 106 is comprised of the first plate 302, and the front surface 104 is comprised of the second plate 304. The first plate 302 can be comprised of material that is attracted to magnets, while the second plate 304 can be comprised of any type of material, magnetic and/or non-magnetic. In some aspects, the first plate 302 can be comprised of galvanized steel and the second plate 304 can be comprised of aluminum. Aluminum is not attracted to magnets, but a magnet placed on the second plate 304 will be held onto the plate 102 due to the first plate 302 being comprised of galvanized steel and attracted to magnets. The plate 102 mounted on the at least one display mount 110 is positioned such that the plate 102 is within a first plane, in a manner similar as discussed in the aspect of FIG. 2c. The front surface 304 of the plate 102 extends along the first plane, such that the item 150 is displaced from the first plane. Additionally, the at least one display mount 110 is arranged such that the item 150 can be positioned within a second plane. The second plane is offset from the first plane based on the dimensions of the at least one display mount 110. The at least one display mount 110 provides a surface to receive the item 150 that is within the second plane. The surface provided by the at least one display mount 110 can be the same or different to the front surface 304 of the plate 102. In some aspects, as shown in FIG. 3c, multiple items can be mounted onto the front surface 304 wherein each respective item is mounted by a respective at least one display mount 110. In such aspects, each item can be offset from the front surface 304 at the same and/or different distance, such that each item can be within a same and/or different second plane.

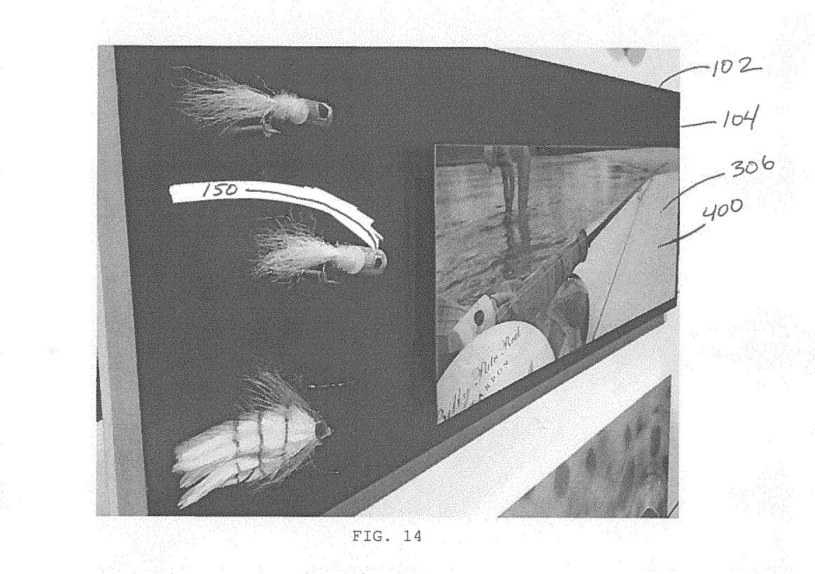

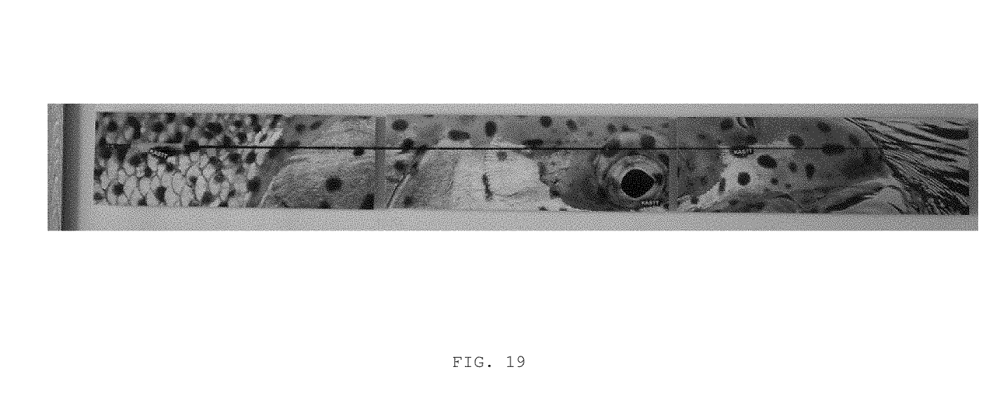

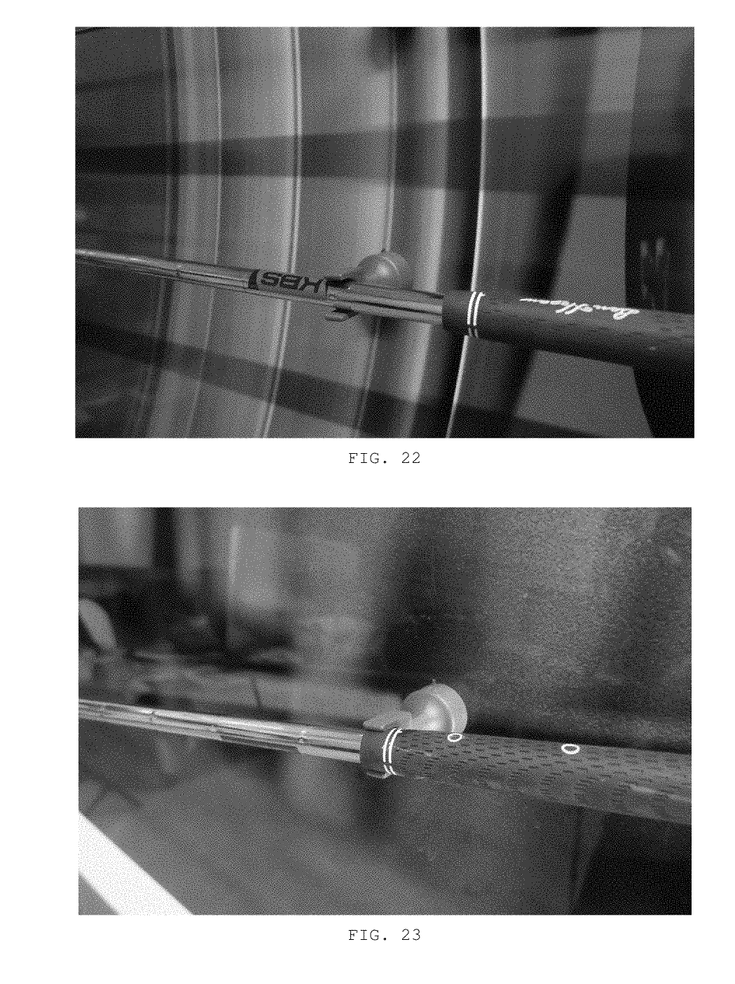

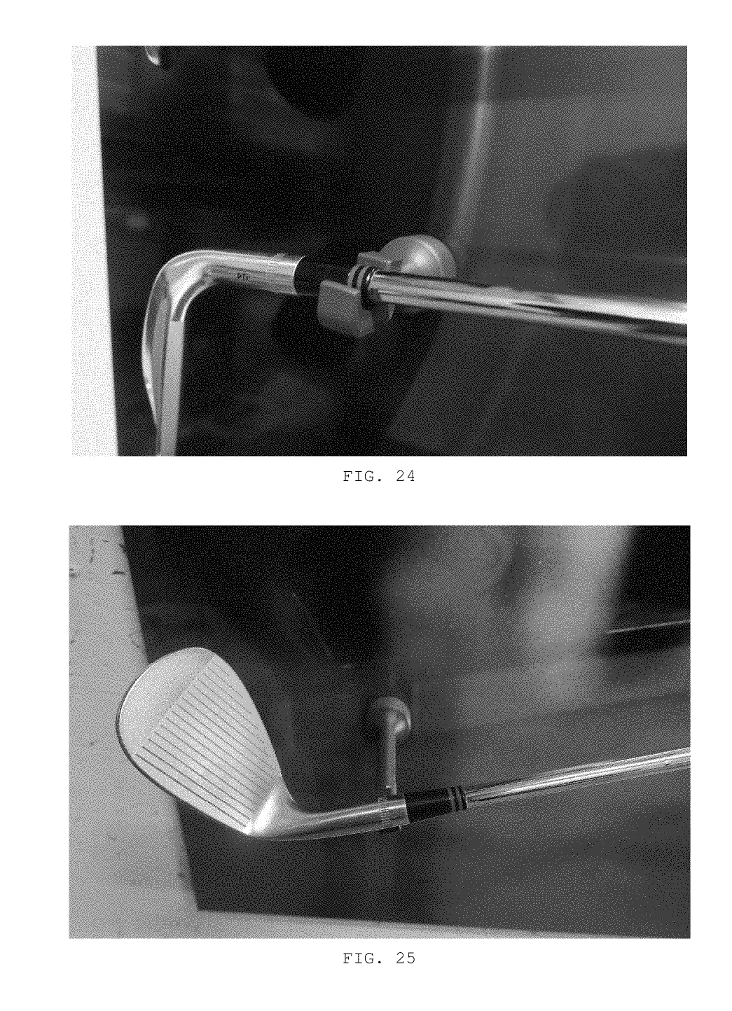

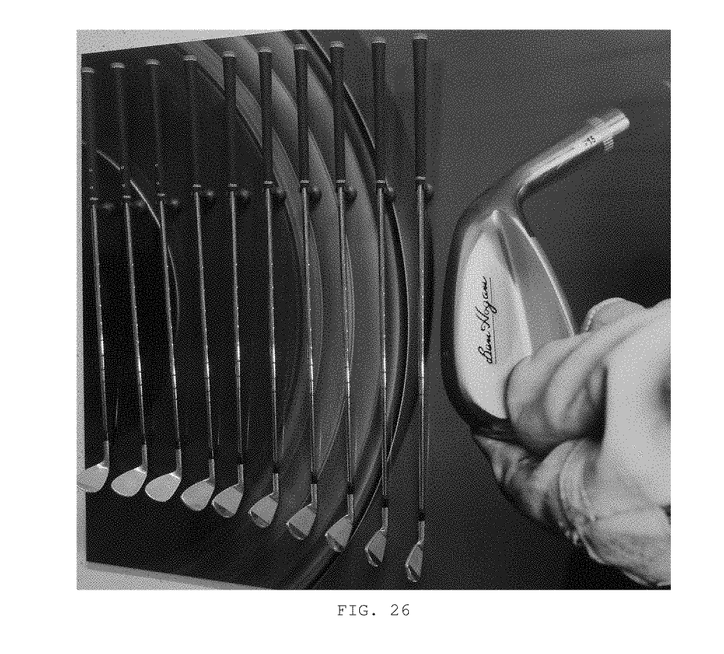

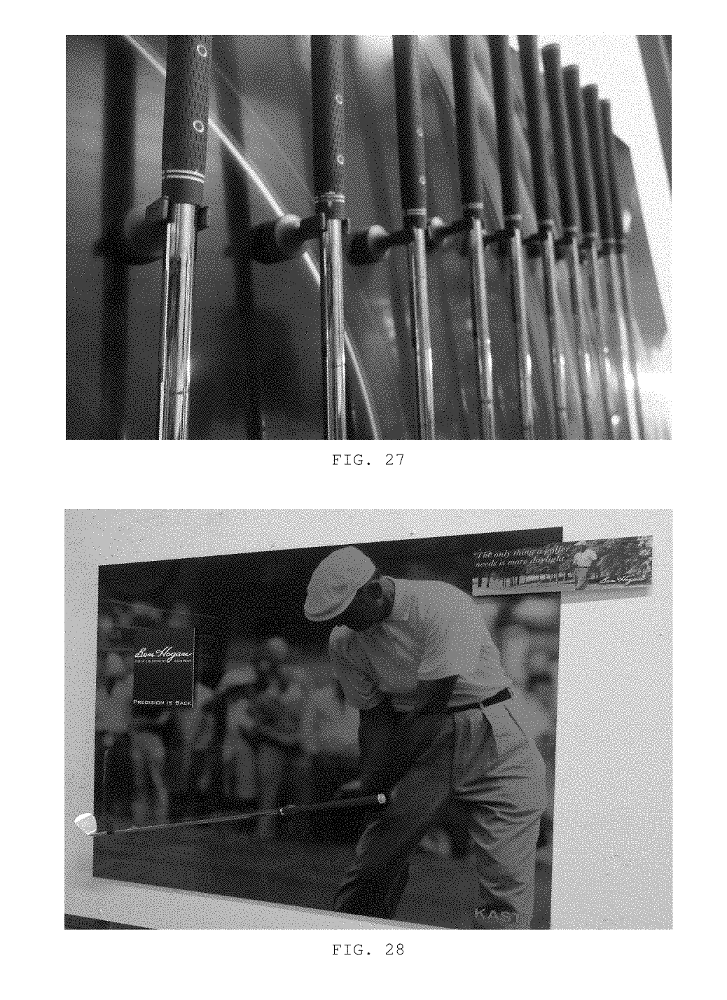

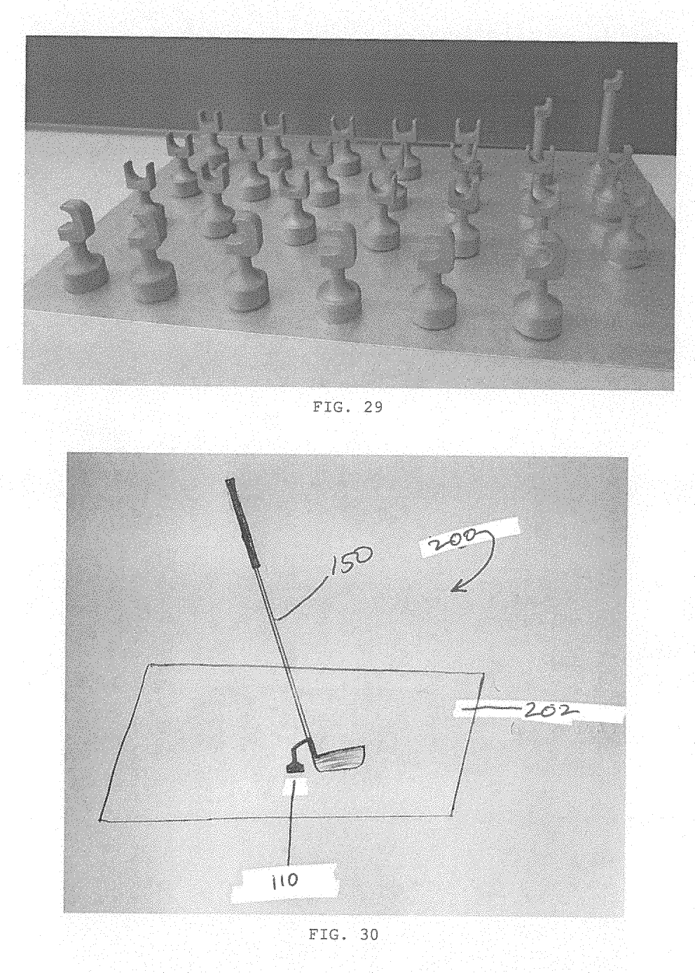

In some aspects, the second plate 304 comprised of aluminum can comprise an image 306 printed on the aluminum plate, such that the image 306 is on the front surface 104 of the plate 102. Aluminum prints are becoming more common and are typically hung with traditional picture hanging methods. At least one advantage of the disclosure is that coupling an aluminum print to a galvanized plate results in the aluminum print having magnetic-like properties, such that an item 150 can be positioned with respect to the image 306 of the aluminum print, as shown for example in FIGS. 13, 14 and 17-28. The plate 102 comprised of the aluminum print and galvanized steel allows for the aluminum print to appear as if it is floating on the wall 140, due to the plate 102 being mounted onto the magnetic plate mounts 108.

In some aspects, more than one magnetic plate mounts 108 can be mounted to a wall or surface 140 to receive the plate 120. At least one advantage of using more than one magnetic plate mounts 108 is that the holding power of the more than one magnetic plate mounts 108 is increased, which allows for heavier plates 120 and/or items 150 to be mounted to the wall or surface 140. In addition, using one or more magnetic plate mounts allows for ease of mounting the plate to the wall, as well as aligning and/or adjusting the plate. Also, the plate comprising an aluminum print and galvanized steel allows for easily changing the images mounted on the wall by removing the existing plate and mounting another plate having a different aluminum print. In some aspects, the first plate 302 and second plate 304 can be permanently affixed to each other. However, in some aspects, the first plate 302 and second plate 304 are removably coupled to each other such that the second plate 304 can be removed from the first plate 302 and replaced with a different second plate 304. The different second plate 304 can be another aluminum print that comprises a different image 306, such that changing the image mounted on the wall only requires changing out the second plate 304, instead of replacing both the first and second plates 302, 304. In some aspects, the different second plate 304 can be comprised a different material than that of the original second plate 304, such that different items 150 can be mounted onto the wall instead of mounting another image 306. The plate 102 is highly customizable and allows for a variety of items 150 to be mounted/displayed on the wall. The first and second plates can be coupled to each other using many known fastening means, such as but not limited to adhesives, fasteners, screws, bolts, rivets, and the like, and/or a combination thereof. The second plate 304 comprising the aluminum print can be the same size and/or shape of the first plate 302 comprised of galvanized plate. In some aspects, the second plate 304 comprising the aluminum print can have a smaller size and/or shape than the first plate 302 comprising the galvanized steel plate, such that part of the galvanized steel extends beyond the aluminum print. The aluminum print can be arranged in many different ways, and in some aspects comprises an image, photograph, and/or any graphic design. The second plate 304 comprising the aluminum print can be mounted to a wall due in part to the magnetic plate mount(s) 108.

The second plate 304 can be comprised of many different materials and is not intended to be limited to aluminum prints. In some aspects, the second plate 304 can be comprised of wood, paper, fiberglass, marble, plastic, organic material, inorganic material, and the like, and/or a combination thereof. Thus, the second plate 304 which receives the at least one display mount 110 can be formed of any material. In some aspects, the plate 102 comprises a plurality of plates wherein at least one magnetic plate is interposed between at least two non-magnetic plates. In such an aspect, the at least one magnetic plate is not in direct contact with the magnetic mount 108, and has at least one non-magnetic plate interposed between the magnetic mount 108 and the at least one magnetic plate. The plate is mounted onto the wall or surface 140 by the magnetic mount 108. In some aspects, the non-magnetic plates enclose the at least one magnetic plate such that the at least one magnetic plate is not visible, which allows for instances wherein the plate can have items mounted to both sides of the plate. Additionally, the at least one magnetic plate being enclosed allows the plate to be aesthetically pleasing and does not detract from the decorative aspects of the non-magnetic plates enclosing the at least one magnetic plate.

In some aspects, the at least one display mount 110 can comprise a magnetic display mount, as shown for example in FIGS. 2b and 3b. The magnetic display mount 110 can be similar and/or different to the at least one magnetic plate mount 108. In some aspects, the magnetic display mount 110 can comprise cylindrical magnets that receive the item to be mounted. The cylindrical magnetic display mount 110 that receives the item 150 displaces the item 150 from the plate 102, such that the item 150 is offset from the front surface 104, 304 of the plate. This gives the impression and/or aesthetic effect that the item 150 appears to be floating with respect to the plate 102. The height of the cylindrical magnetic display mount 110 allows the item 150 to float off the front surface 104, 304 of the plate 102. As shown in FIG. 2b and 3b, the item 150 is shown as being offset from the plate 102 by a distance “D”, while the plate 102 shown as being offset from the wall by a distance “d”. The offset of either the plate and/or the item can be a function of the dimensions of the magnetic plate mount and the magnetic display mount, respectively. In some aspects, the magnetic plate mount can comprise one magnetic plate mount, as shown in FIGS. 2b and 3b, for example. However, in some aspects, the magnetic plate mount can comprise more than one magnetic plate mount such that multiple magnetic plate mounts can be joined to adjust and/or alter the offset distance “d”. The offset of the item 150 from the plate can also be altered in a manner similar to the magnetic plate mount, such that one or more magnetic display mounts can be joined to adjust and/or alter the offset distance “D”. The multiple magnetic plate mounts can have the same or different dimensions, and/or can have the same or different shape. In addition, the multiple magnetic display mounts can have the same or different dimension, and/or can have the same or different shape. The magnetic display mount 110 can comprise many different shapes and is not intended to be limited to cylindrical shaped magnets. In some aspects, the shape of the magnetic display mount 110 can be rectangular, triangular, circular, tapered, polygonal, or the like, and/or a combination thereof. The magnetic display mount 110 can comprise many different magnets, such as but not limited to, neodymium magnets, rare earth magnets, and the like, and/or a combination thereof. The magnetic display mount 110 has a holding power sufficient to hold the item 150, and does not need to have the same holding power as the magnetic plate mount 108. As a result, in some aspects, the magnetic display mount 110 can be smaller than the magnetic plate mounts 108, such that the magnetic display mount 110 does not detract from the aesthetic properties of the mounted item 150 and/or the front surface 104, 304 of the plate 102. For example, in aspects wherein the plate 102 comprises an aluminum print and a galvanized steel plate, the item 150 received by the magnetic display mount 110 does not substantially block and/or cover the item 150 because the magnetic display mount 110 is interposed between the plate 102 and the item 150. As such, substantially all of the item 150 is visible and not covered and/or blocked by the magnetic display mount 110. Conventional magnetic mounting systems typically require the item to be interposed between the mount surface and the magnet, such that the magnet covers part of the item and thereby diminishes the aesthetic properties of the item.

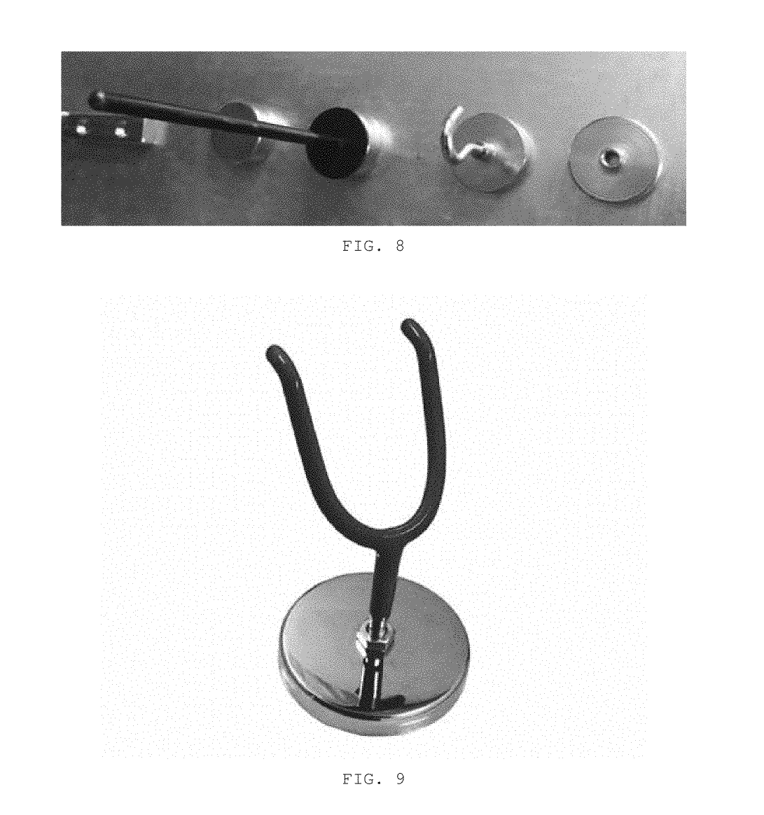

In some aspects, as shown for example in FIG. 1, 2b, 2c, 3b, 3c, 13, and 14, the item or part of the item received by the magnetic display mount can be attracted to magnets. In such instances, the item is mounted to the first surface of the plate by the magnetic display mount. However, in some aspects, the item received by the magnetic display mount is not attracted to magnets, as shown for example in FIGS. 2a, 3a, 11, 15-28, and 30-37. In such instances, the magnetic display mount can be configured to hold and/or carry the item, such that the item can rest on or within and/or hang from the magnetic display mount, as shown for example in FIGS. 8-11, 15-19 and 21-37. In some aspects, the magnetic display mount can comprise a hook to receive the item, as shown in FIG. 7. In some aspects, the magnetic display mount can comprise at least one extension extending from the magnetic display mount such that the extension provides a surface wherein the item can rest on and/or hang from the surface, for example as shown in FIGS. 8-11. In some aspects, the magnetic display mount can comprise a multi-pronged mount to receive the item. In some aspects the item can be held between adjacent prongs of the multi-pronged mount, as shown in FIGS. 15, 16, and 21-28. While in some aspects, each prong can be configured to hold a respective item. The magnetic display mount can be arranged in many different configurations, and is not intended to be limited to the aspects disclosed herein. In some aspects, the magnetic display mount can comprise a covering, wherein the item received by the magnetic display mount rests and/or hangs from part of the magnetic display mount comprising the covering. The covering can be configured to provide a soft surface and/or a protective surface such that the item is not damaged when received by the magnetic display mount. In some aspects, the covering can be comprised of plastic, while in some aspects, the covering can be comprised of fur-like material. In some aspects, the covering can provide a tacky surface to assist in holding the item. In some aspects, the covering can provide a textured surface to assist in holding the item. The covering can be comprised of many different materials and/or can provide many different surfaces and is not intended to be limited to the aspects disclosed herein.

At least one advantage of the disclosure is that the magnetic mounting system 100 can be used to display an item 150 on a wall or surface 140, wherein the item 150 can be positioned with respect to an image 306 on the plate 102. The magnetic mounting system 100 allows for users to further customize an image 306 mounted on a wall or structure 140 by mounting 3-dimensional items with respect to the image 306 by using the magnetic display mount 110. The item 150 can add further details to the image and/or substance that might not be included in the image on the plate. For example, an image on the plate could be of a recent fishing trip and have a photo of a fish caught. The magnetic mounting system can allow the plate having the photo of the caught fish to be mounted on the wall, but the magnetic display mount can also allow the fishing lure and/or rod used to catch the fish to also be displayed on the plate with the photo of the caught fish, as shown for example in FIGS. 13, 14, and 17-19. As such, the magnetic mounting system allows a user to further customize the photo and provide more details. The user can further customize the photo on the plate to their liking and display many items on the plate.

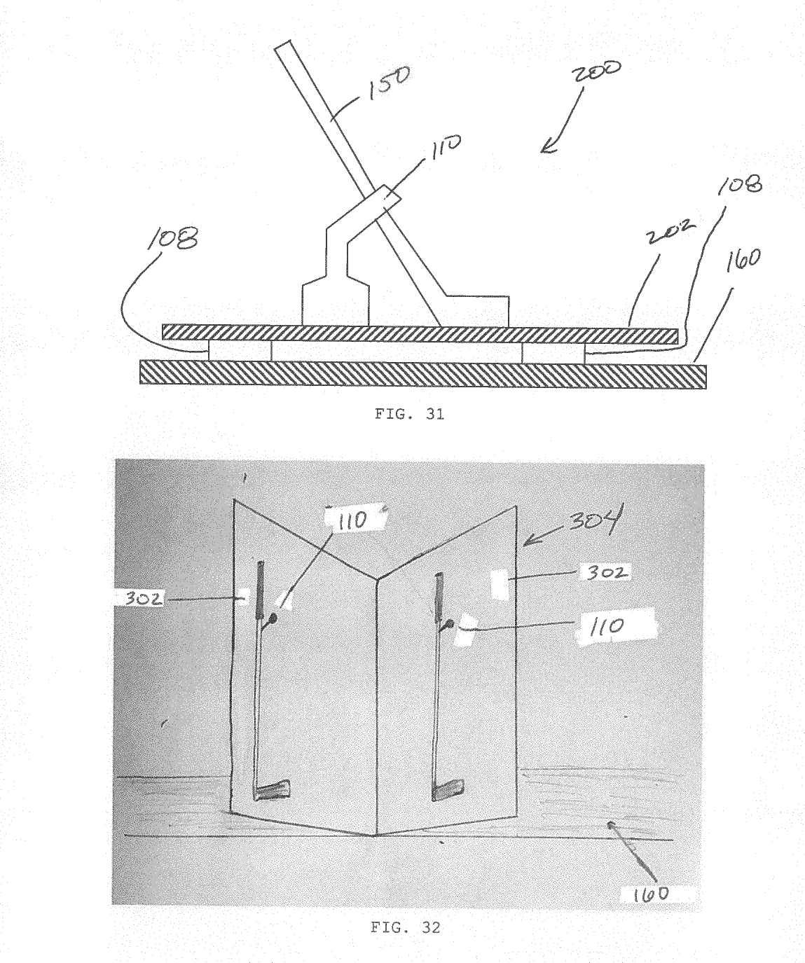

The magnetic mounting system has been discussed herein as mounting an item onto a wall or surface. However, the magnetic mounting system is not intended to be limited to mounting an item onto a wall or surface. In some aspects, the magnetic mounting system can be used to mount an item onto a floor, a ceiling, or other structure. In some aspects, as shown in FIGS. 30 and 31, a magnetic mounting system 200 is configured to mount an item 150 to a floor 160, wherein the plate mount 108 is mounted onto the floor 160, the plate 202 is received by the plate mount 108 on the floor, and at least one display mount 110 is on the plate 202. The at least one display mount 110 is configured to hold and/or receive the item 150 in order to mount the item onto the floor. The display mount 110 can be forked or comprise at least one prong, as shown in FIG. 29, to receive the item 150, such that gravity assists in holding the item 150 within the display mount 110. The magnetic mounting system 200 of FIGS. 30 and 31 are similarly configured to the magnetic mounting systems discussed above. In some aspects, the magnetic mounting system 200 does not comprise plate mounts 108 and the plate 102 can rest on the floor 160 or could be secured on the floor 160 using a screw, bolt, rivets, the like, or other known means of securing a plate to a floor, and/or a combination thereof. In some aspects, the plate 202 is on a display floor, such as, but not limited to a pedestal, such that the plate 202 is at least partially elevated from the floor 160. In some aspects, the plate 102, 202 can be mounted to a free standing structure, such as but not limited to a pole, instead of a wall or floor.

In some aspects, as show in FIG. 32, a plate 302 can comprise a plurality of plates 302 coupled to form a free standing structure 304 that can be placed on a floor 160. For example, the aspect of FIG. 32 discloses two plates 302, 302 coupled together to form a triangular structure 304 that can stand freely on the floor 160. The two plates can be configured similarly as any of the plates discussed herein. The two plates and be used as floor displays to display the items 150 mounted on the plates. In some aspects, the plate 302 can be one plate formed into a triangular structure 304 instead of coupling a plurality of plates together. The plate can be any shape and is not intended to be limited to a triangular shape. In some aspects, the plate can be formed to be circular, cylindrical, quadrilateral, or any polygonal shape. In some aspects, the plurality of plates can be coupled into many different shapes as discussed herein. The free standing structure 304 allows the plate 302 to display the item mounted to the plate, such that the plate is easily transportable and easily exhibited. The plate can also comprise an image or graphic as discussed above, such that the item mounted on the plate can be arranged with respect to the image or graphic on the plate. In some aspects, the plurality of plates 302 can be collapsible such that the free standing structure 304 can be easily stored and transported between locations. In some aspects, the plurality of plates 302 are hingedly coupled to each other such that the free standing structure 304 can fold up. In some aspects, the plurality of plate 302 are removably coupled such that the free standing structure 304 can be disassembled.

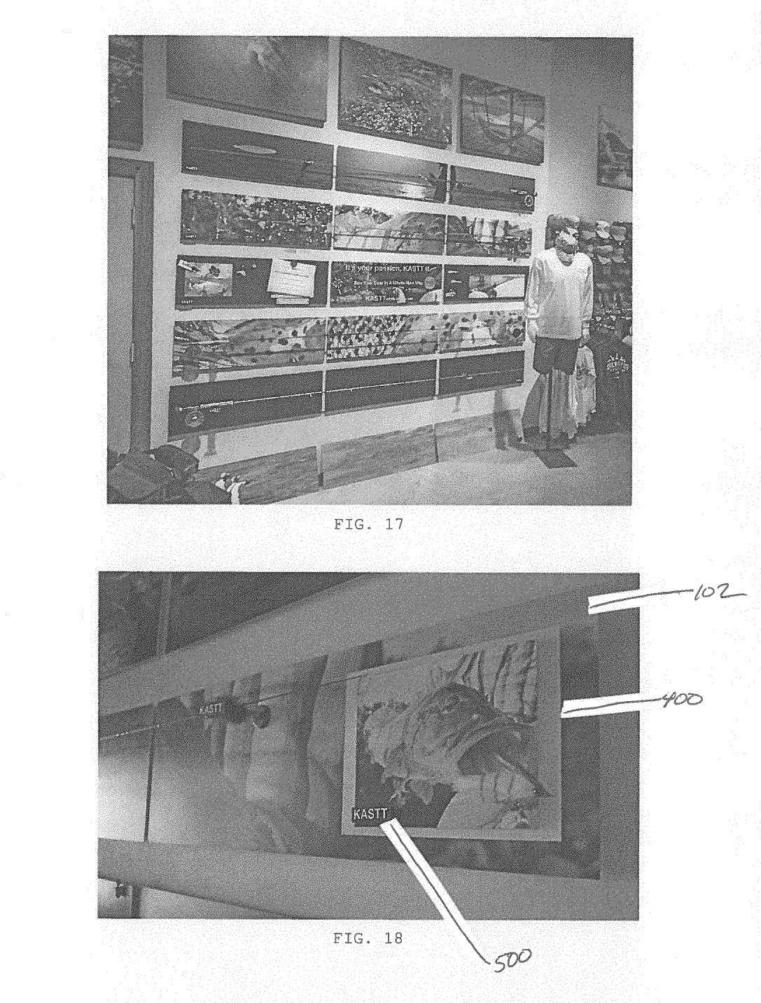

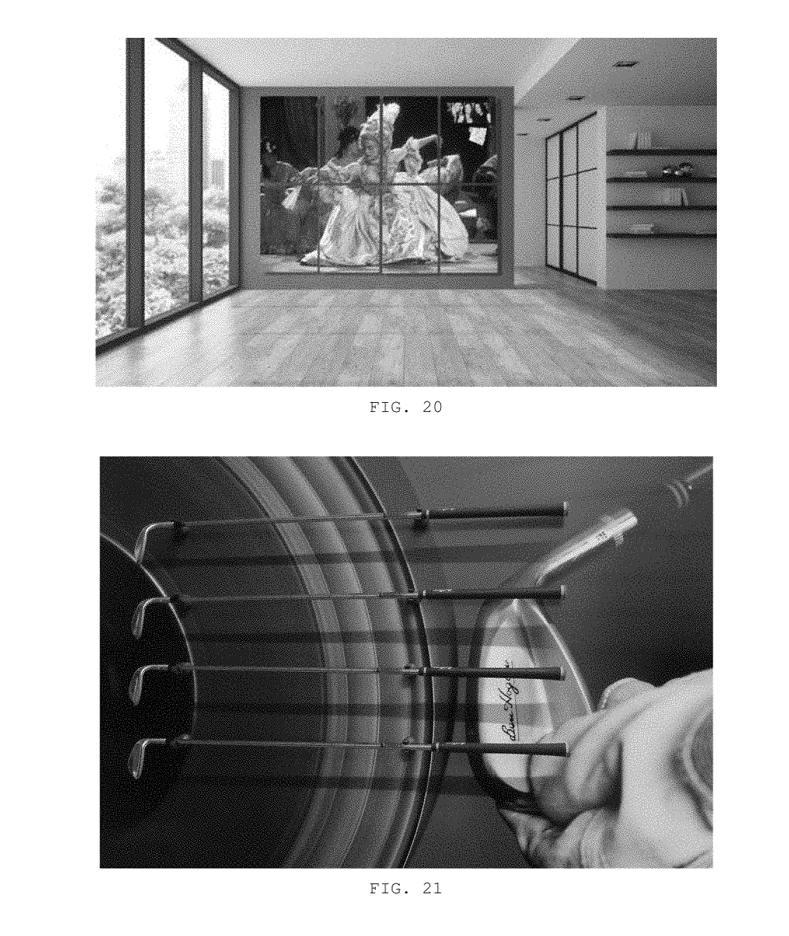

In some aspects, the magnetic mounting system can be used to display various items on the plate. For example, the magnetic mounting system can be used as a product display arrangement in a retail setting or the like. For instance, an item can be mounted on a wall, surface, or floor using one or more plates, wherein the one or more plates comprise a picture related to the mounted item. For example, a fishing rod can be mounted on a wall using a plurality of plates and a plurality of display mounts, wherein each plate has part of a picture such that when the plurality of plates are properly aligned they form a full length picture related to the fishing rod, such as but not limited to a fish, as shown in FIGS. 17-19. In another example, the fishing rod can be exhibited on a plate arranged as a free standing structure with the free standing structure on a floor. These forms of displaying a fishing rod, or other item for sale, can enhance the item aesthetics which can be advantageous in a commercial sense. The items mounted are not intended to be limited to fishing related items. Various items can be mounted to a wall or surface using the magnetic mounting system of the disclosure. In yet another example, one or more golf clubs can be mounted to a wall using the magnetic mounting system, as shown in FIG. 21-28. The one or more golf clubs can be mounted on a plate 102 that has or does not have an aluminum print. The magnetic mounting system allows for the one or more golf clubs 150 to be aligned with respect to the aluminum print 306, and can be easily adjusted as desired by the user.

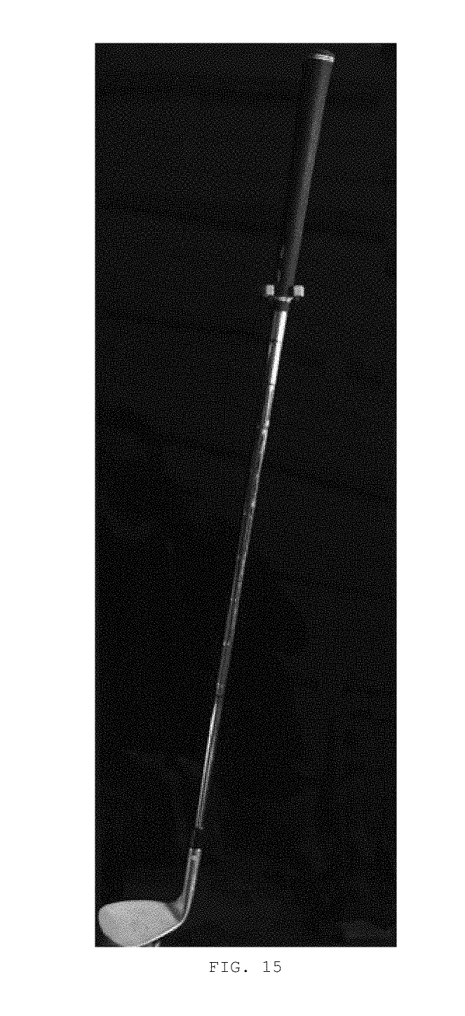

In yet other aspects, one or more display plates 400 can be mounted on the front surface 104 of the plate 102. The display plates 400 are mounted onto the front surface 104 of the plate 102 by one or more magnetic display mounts 110. The display plates 400 can comprise a photo or image 306, while the plate 102 mounted onto the magnetic plate mount 108 is intended to be a background surface. The background surface plate 102 is much bigger than the display plate 400 and can provide additional surface for other items 150 to be mounted onto the background surface plate 102, as shown in FIG. 14. In some aspects, the background surface plate 102 is within a first plane, the display plate 400 can be within a second plane and can also have a second display plate 500 mounted on the display plate 400. The second display plate 500 can be within a third plane and can be a title plate that can provide a text description of the image 306 on the display plate 400. In some aspects, the second display plate 500 can also be mounted on the background surface plate 102 such that the second display plate 500 can be within the second plane or a different plane with respect to the background surface plate 102 and is not intended to be limited to being on the display plate 400. The customization of the magnetic mounting systems disclosed herein allows the user to configure the display plates 400, 500 as desired and does not cause further damage to the wall or surface.

The magnetic mounting system is not intended to be limited to be used in a retail setting to display merchandise. The magnetic mounting system can also be used in a private or public setting to display a photo and/or artwork. For example, a picture can be arranged to be printed on multiple plates, such that properly aligning the multiple plates forms the picture, as shown in FIG. 20. The picture can be any type of picture, such as but not limited to, a concert, play, sporting event, family picture or the like. The combination of plates forming the picture can also have an item mounted to one or more of the plates. For example, a ticket stub of the concert, play, or sporting event can be mounted onto the one or more plates. While in aspects with a family picture, a souvenir associated with the picture can be mounted on the one or more plates. The magnetic mounting system allows the user to further customize a picture in order to add more information to the picture. In yet other aspect, the magnetic mounting system can be used to mount tools, sports equipment, knives, pots, pans, bikes, guns, and the like on one or more plates. The plates can comprise an image but it is not necessary.

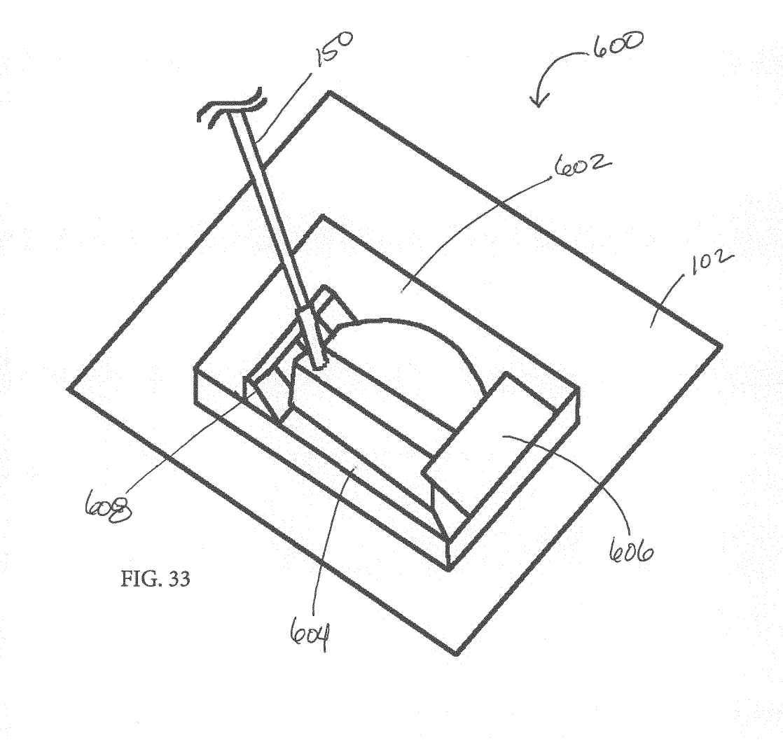

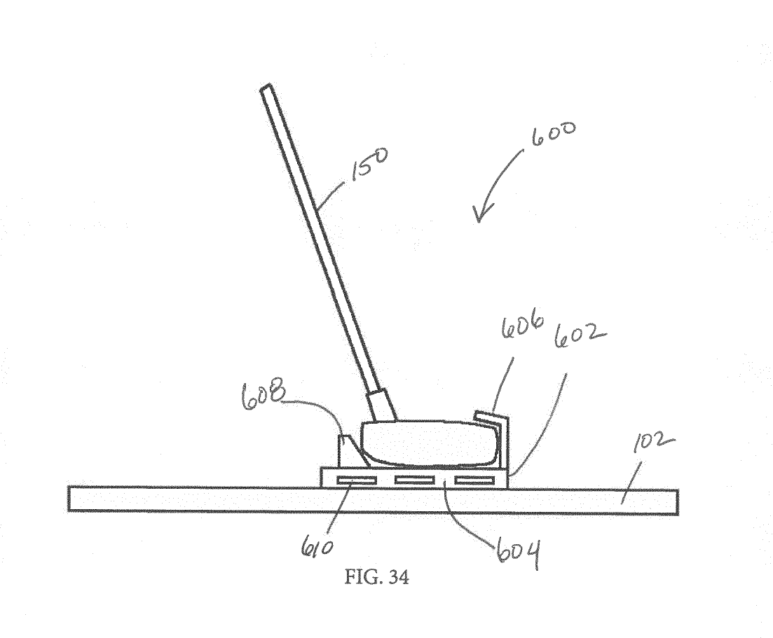

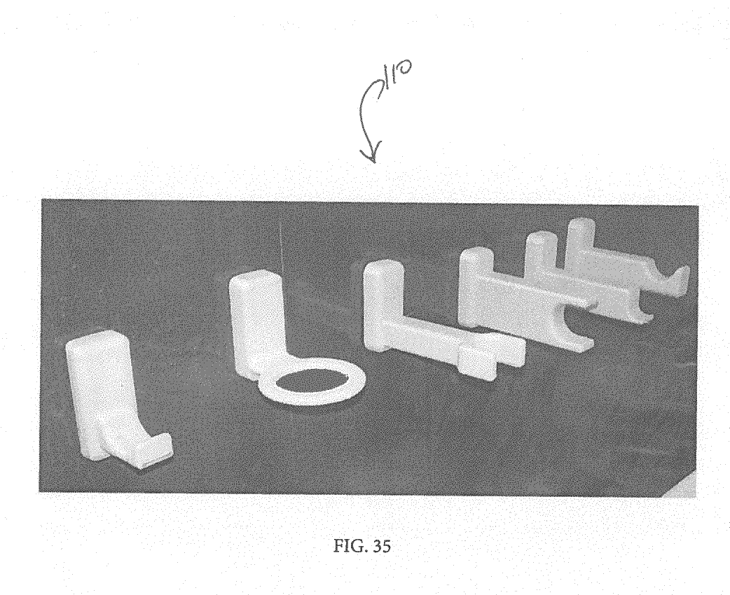

In some aspects, as shown in FIGS. 33 and 34, a magnetic mounting system 600 is configured to mount an item 150 onto the plate 102. The magnetic mounting system 600 comprises a magnetic mount 602 comprising a recess 604, a flange 606 extending from said recess 604, a ledge 608, and at least one magnet 610, wherein the magnetic mount 602 is removably coupled to the plate 102 due to magnets 610 within the mount 602. The plate 102 is comprised of magnetic material which allows the mount 602 to be securely held by magnetic forces. The mount 602 comprises a recess 604 that is configured to receive the item 150. The recess 604 is configured to accommodate the shape of the item 150, such that the item is properly received by the mount 602. The recess 604 acts as a base or floor of the mount 602 such that the item rests within the base of the recess 604. The mount further comprises a flange 606 that extends from the recess 604. The flange 606 is configured to cover part of the item 150 that is received in the recess 604. The part of the flange 606 that covers part of the item 150 assists in holding the item 150 within the recess 604 such that the item 150 is maintained within the mount 602. The flange 604 partially overhangs over part of the item within the recess 604 and prevents the item 150 from falling over by holding onto the item. The mount 602 further comprises a ledge 608 on the recess 604 and opposite the flange 606. The ledge 608 provides a surface to assist in aligning the item 150 within the recess 604 and against the flange 606. The ledge 608 can also provide an angled surface that assists in preventing the item 150 from tipping over in a direction away from the flange 606. In some aspects, the mount 602 does not comprise the flange 606 and is securely held within the mount by the flange 606. The mount 602 can further comprise at least one magnet 610 embedded within the mount 602 or at a back surface of the mount 602 opposite the recess 604. The at least one magnet 610 magnetically couples the mount 602 to the plate 102, thereby mounting the item 150 to the plate 102. At least one advantage of the mount 602 is that the item 150 can be displayed in a vertical manner with respect to the plate 102. In some aspects, the plate 102 can be arranged on a mobile display case such that the plate is not mounted to a wall or structure. The mounting system 600 is conducive for being utilized in retail display settings to display products.

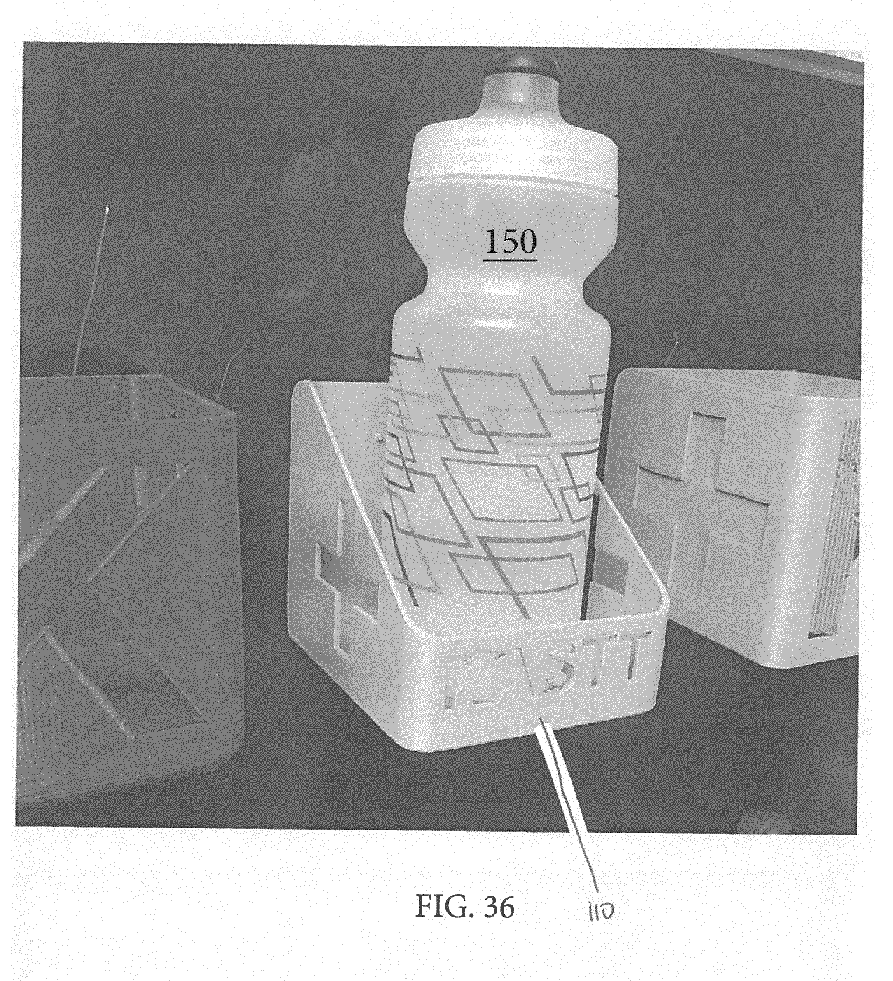

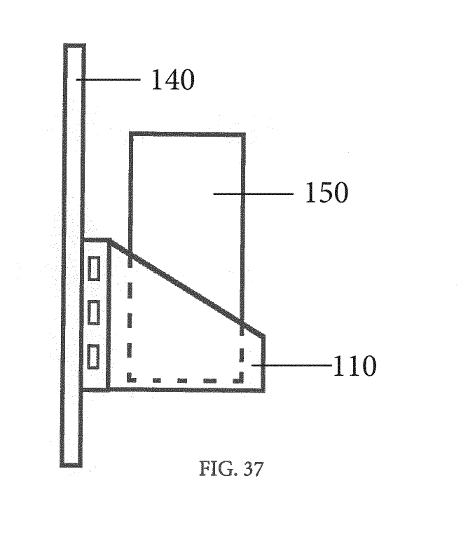

The components of the magnetic mounting systems disclosed herein can be arranged in many different configurations and are not intended to be limited to the aspects disclosed herein. In some aspects, the display mounts 110 can be arranged in many different shapes. For example, as shown in FIG. 35, the display mounts 110 can be configured to be horizontal, vertical, single prong, multi-prong, or ring-shaped. In some aspects, as shown in FIGS. 36 and 37, the display mount 110 can be arranged to be a storage container, such that an item can be stored and/or housed within the display mount 110. In the aspects of FIGS. 36 and 37, the display mounts comprise a receptacle configured to receive and hold a water bottles. However, the display mounts of FIGS. 36 and 37 can hold various items and are not intended on being limited to holding water bottles. These display mounts 110 comprise at least one magnet within the mounts in order to magnetically couple the mount to a plate.

Although the disclosure has been described in considerable detail with reference to certain configurations thereof, other version are possible. Magnetic mounting systems according to the disclosure can be many different sizes and can be used to mount items to various types of walls, surfaces and structures. The magnetic mounting system can comprise non-planar plates, such that the plate can be curved, faceted, and/or provide multiple surfaces to receive a display mount. In other aspects, multiple magnetic plate mounts can be mounted on top of one another to further strengthen the holding power of the magnetic plate mount. The magnetic display mounts can comprise a rubber coating, wherein the rubber coating is interposed between the plate and the magnetic display mount, such that the magnetic display mount does not scratch the plate. Furthermore, the magnetic display mounts, can be comprised of one or more magnetic display mounts to enhance the holding power of the magnetic display mount. Therefore, the spirit and scope of the disclosure should not be limited to the versions described herein.

We claim:

1. A magnetic mounting system, comprising:
at least one plate having a front surface and a back surface;
at least one plate mount configured to receive the at least one plate and mount the at least one plate to a surface;
at least one display mount removably coupled to the at least one plate opposite the at least one plate mount, wherein the at least one display mount is configured to receive an item, such that the item is mounted to the surface;
wherein the at least one plate is comprised of material attracted to magnets, the at least one plate mount comprising at least one magnet, and the at least one display mount comprises at least one magnet;
wherein the at least one plate mount exerts a magnetic force onto the at least one plate in order to mount the at least one plate to the surface.

2. The magnetic mounting system of claim 1, wherein the at least one plate mount is affixed to the surface.

3. The magnetic mounting system of claim 2, wherein the at least one plate mount is removably coupled to the back surface of the at least one plate.

4. The magnetic mounting system of claim 1, wherein the at least one display mount is removably coupled to the front surface of the at least one plate.

5. The magnetic mounting system of claim 4, wherein the at least one display mount provides at least one surface to hold the item.

6. The magnetic mounting system of claim 4, wherein the at least one display mount provides at least one magnetic surface to magnetically couple the item to the at least one magnetic surface.

7. The magnetic mounting system of claim 6, wherein part of the item is comprised of magnetic material such that the item can be removably coupled to the at least one display mount.

8. The magnetic mounting system of claim 1, wherein the system comprises a plurality of plates each having a front surface and a back surface, wherein each of the plurality of plates comprises a part of a graphic such that the proper alignment of the plurality of plates forms a completed graphic.

9. The magnetic mounting system of claim 8, wherein each of the plurality of plates comprises a respective display mount wherein an item can be received by each of the respective display mounts of the plurality of plates, wherein the item is sized to span along the length of the completed graphic.

10. A magnetic mounting system, comprising:
at least one plate having a front surface and a back surface;
a first means for mounting the at least one plate to a surface, in which the first means mounts the at least one plate within a first plane;
a second means for supporting a display item proximate the at least one plate opposite the first means, in which the second means supports an item within a second plane;
wherein the first means is removably coupled to the back surface of the at least one plate;
wherein the second means is removably coupled to the front surface of the at least one plate.

11. The magnetic mounting system of claim 10, wherein the at least one plate is offset from the surface by the first means.

12. The magnetic mounting system of claim 10, wherein the at least one plate is offset from the item by the second means.

13. The magnetic mounting system of claim 10, wherein the at least one plate comprises a first plate and a second plate, wherein the first plate is proximate the surface and the second plate is proximate the item.

14. The magnetic mounting system of claim 13, wherein the first plate is removably coupled to the first means and the second plate is removably coupled to the second means.

15. The magnetic mounting system of claim 14, wherein the first and second plate are permanently affixed.

16. The magnetic mounting system of claim 14, wherein the first plate is comprised of galvanized steel and the second plate is comprised of an aluminum print.

17. A magnetic mounting system, comprising:
at least one plate configured to display an item on the at least one plate;
a magnetic mount on the at least one plate configured to receive the item, the magnetic mount comprising:
a recess;
a flange extending from the recess;
a ledge on the recess and opposite the flange; and
at least one magnet, wherein the magnetic mount is removably coupled to the at least one plate by the at least one magnet.

18. The magnetic mounting system of claim 17, wherein the item is displayed on the at least one plate in a substantially vertical orientation.

19. The magnetic mounting system of claim 17, wherein the at least one plate is mounted on a mobile structure.

20. The magnetic mounting system of claim 17, wherein the item is received within the recess of the magnetic mount, wherein the flange is configured to accommodate the shape of the item such that the item is interposed between the flange and the recess, wherein the flange applies a downward force onto the item to hold the item within the recess.
